(19) United States
(12) Patent Application Publication
(10) Pub. No.: US 2016/0100137 A1
(43) Pub. Date: Apr. 7, 2016

(54) SMART DEVICE AND RELATED SYSTEMS AND METHODS

(71) Applicant: T+Ink, Inc., New York, NY (US)

(72) Inventors: John Gentile, Montclair, NJ (US); Terrance Z. Kaiserman, Loxahatchee, FL (US); Steven Martin Cohen, New York, NY (US); Anthony Gentile, New York, NY (US); Tayler Kaiserman, Brooklyn, NY (US); Adam Joffee, New York, NY (US)

(73) Assignee: T+Ink, Inc., New York, NY (US)

(21) Appl. No.: 14/709,167

(22) Filed: May 11, 2015

Related U.S. Application Data
(60) Provisional application No. 61/990,862, filed on May 9, 2014.

(51) Int. Cl. H04N 9/04; H04N 5/232; G06F 3/044; H04N 9/73

(52) U.S. Cl. CPC H04N 9/045; H04N 9/73; H04N 5/23293; G06F 3/044

(57) ABSTRACT

An electronic device is provided. The electronic device may include components. The components may include a power source, a processor, a memory, circuitry, an input/output unit, a display unit configured to display data and/or color, and a communication unit configured to transmit and/or receive data. The electronic device may include a conductive material connecting at least two of the components to each other. At least a portion of the electronic device may be formed in one or more layers of a printed substrate, and/or at least one of the components may be formed from a conductive ink.

### RELATED APPLICATIONS

This application claims priority to U.S. Provisional Application No. 61/990,862, filed May 9, 2015, which is incorporated herein by reference in its entirety.

### BACKGROUND

1. Field

The present disclosure relates to printed material, data entry and display, electronic color generation, and data communication. More particularly, some embodiments described in the present disclosure relate to a magazine or printed material insert (e.g., flat-shaped) using electricity to perform many of the same functions as a smart device.

2. Related Art

Magazine inserts have been around almost as long as there have been magazines and print. Offers and subscriptions and self-addressed cards with or without prepaid postage are inserted within the pages of magazines, and these are meant to be torn out or removed and mailed in. There are also larger fold out ads. Inserts have now gone beyond print only, with, for example, fragrances.

Touch codes may include information structures which are readable by capacitive sensors, including, but not limited to, touchscreens or touch-sensitive sensors.

### SUMMARY

According to an aspect of the present disclosure, a smart device is provided, comprising at least one camera and a processor configured to perform a method. The method comprises controlling the at least one camera to acquire one or more images of one or more respective color standard samples of known chromaticity coordinates, resolving the one or more images of the one or more color standard samples of known chromaticity coordinates into component color contributions, and producing a color acquisition map between the chromaticity coordinates of the one or more color standard samples and the corresponding component color contributions.

According to an aspect of the present disclosure, a smart device is provided, comprising at least one camera, at least one display unit, an input controller configured to determine an input to the at least one camera, and a processor configured to perform a color calibration method. The color calibration method comprises controlling the at least one display unit to display one or more test colors by applying one or more respective sets of display settings to components of the at least one display unit, controlling the one or more input controllers to provide light produced by the at least one display unit to the at least one camera, controlling the at least one camera to acquire one or more images of the one or more test colors displayed by the at least one display unit in response to application of the one or more respective sets of display settings, resolving the one or more images one the one or more test colors into one or more respective sets of average component color contributions, determining one or more differences between (1) the one or more sets of display settings applied to produce the one or more test colors, and (2) the corresponding one or more sets of average component color contributions resolved from the one or more images of the one or more test colors, and using the one or more differences between the one or more sets of display settings and the one or more sets of average component color contributions to determine elements of a color correction matrix for converting average component color contributions of a specified color into display settings which, when applied to the display unit, cause the display unit to display a target color.

According to an aspect of the present disclosure, a smart device is provided, comprising a display unit and a processor configured to perform a color calibration method. The color calibration method comprises acquiring a representation of a target color, determining average component color contributions of the target color from the representation of the target color, and using a color correction matrix and the average component color contributions of the target color to determine calibrated display settings which, when applied to the display unit, cause the display unit to display the target color.

According to an aspect of the present disclosure, an electronic device is provided, comprising components and a conductive material. The components include at least one power source, a processor, a memory, circuitry, at least one input and/or output, a display unit configured to display data and/or color, and a communication unit configured to transmit and/or receive data. The conductive material connects at least two of the components to each other. At least a portion of the electronic device is formed in one or more layers of a printed substrate, and/or at least one of the components is formed from a conductive ink.

### BRIEF DESCRIPTION OF DRAWINGS

Various embodiments will be described with respect to the following Figures. It should be appreciated that the Figures are not necessarily drawn to scale. In the drawings, each identical or nearly identical component that is illustrated in various figures is represented by a like numeral. For purposes of clarity, not every component may be labeled in every drawing. In the drawings:

FIG. 1 shows a components of a smart ad system, according to some embodiments.

FIGS. 2A and 2B show different touch sensitive switches, according to some embodiments.

FIGS. 3A and 3B show different touch sensitive variable resistance rheostats, according to some embodiments.

FIG. 4 shows a matrix of touch sensitive switches, according to some embodiments.

FIG. 5 shows a capacitive sensor, according to some embodiments.

FIG. 6 shows two capacitive sensors, according to some embodiments.

FIG. 7 shows a general smart ad system communicating with other devices, according to some embodiments.

FIG. 8 shows a smart phone using its own camera to acquire an image of the light coming from its own screen using four mirrors, according to some embodiments.

FIG. 9 shows a smart phone using its own camera to acquire an image of the light coming from its own screen using a light feedback pipe, according to some embodiments.

FIG. 10 shows a smart phone using its own camera to acquire an image of the light coming from a series of known color standards, according to some embodiments.

FIG. 11 shows a smart phone using its own camera to acquire an image of the light coming from a smart ad, according to some embodiments.

FIG. 12 shows a chromaticity chart.

The following reference numbers are used in the Figures.
1 smart ad system
2 single touch sensitive switch
3 linear array of touch sensitive switches
4 touch sensitive rheostat
5 touch sensitive rheostat with touch sensitive position switches
6 matrix
8 internet
9 external smart device
10 processor
11 battery
12 capacitor
13 piezo input
14 solar cell
15 touch points
16 sensors
17 speaker
18 microphone
19 mechanisms
20 LEDs
21 touch codes
22 QR codes
23 antenna
24 LCD display
25 auxiliary circuitry
26 other inputs
31 touch sensitive switch common
32 first contact
33 second contact
34 third contact
35 fourth contact
36 fifth contact
37 touch sensitive zone
38 left contact
39 right contact
40 right rail
41 left rail
44 fourth position switch
45 third position switch
46 second position switch
47 first position switch
48 position sensitive left rail
49 position sensitive right rail
50 first vertical bus
51 second vertical bus
52 third vertical bus
53 fourth vertical bus
54 first horizontal bus
55 second horizontal bus
56 third horizontal bus
57 fourth horizontal bus
60 first capacitive touch point
63 second capacitive touch point
70 smart phone
71 camera
72 screen
73 light from screen
74 light incident on camera
75 mirror
76 mirror
77 mirror
78 mirror
80 light feedback pipe
81 first known color standard
82 ith known color standard
83 Nth known color standard
85 light reflected from a known color standard
88 light radiated from a smart ad
89 light generation area of a smart ad
90 CIE white
91 green
92 red
93 blue
96 illuminating light source
97 illuminating light
98 y chromaticity coordinate
99 x chromaticity coordinate

### DETAILED DESCRIPTION

Smart devices, systems and methods are described herein. In some embodiments, the devices, systems and methods may utilize printed material such as magazines inserts and/or other types of advertisements.

In some embodiments, a magazine insert (e.g., flat) is provided. The magazine insert may comprise a battery (e.g., flat) and/or may receive power electromagnetically. The magazine insert may serve as a data entry device, may process and store information, may display information and/or color in at least one area, and/or may receive and/or transmit information.

A “smart device” may comprise any device employing a touch screen that can be activated by a touch code and/or human touch and/or capacitive element and/or conductive element, including, but not limited to: a smart phone, Iphone, Ipad, Android device, a computer, a tablet, a reader, and/or a vending machine. Furthermore, a smart device may be capable of performing tasks including, but not limited to, communicating via wifi and/or electromagnetically, taking pictures and/or video, displaying images, entering and displaying data, near field communication, and/or Bluetooth communication.

Some aspects of touch codes are described, for example, in U.S. patent application Ser. No. 13/576,976, filed Nov. 29, 2011, assigned attorney docket no. T0709.70025US00, titled “System and Method for Retrieving Information from an Information Carrier by Means of a Capacitive Touch Screen,” now U.S. Pat. No. 8,497,850; U.S. patent application Ser. No. 13/120,996, filed Oct. 15, 2009, assigned attorney docket no. T0709.70035US01, titled “Planar Data Carrier,” published as U.S. Patent Pub. No. 2012/0125993; U.S. patent application Ser. No. 13/127,512, filed Nov. 4, 2009, assigned attorney docket no. T0709.70036US00, titled “Identification System and Applications,” now U.S. Pat. No. 8,622,307; U.S. patent application Ser. No. 13/703,467, filed Jun. 10, 2011, assigned attorney docket no. T0709.70037US02, titled “System Comprising a Capacitive Information Carrier for Acquiring Information,” published as U.S. Patent Pub. No. 2013/0115878; and U.S. patent application Ser. No. 13/825,159, filed Sep. 20, 2011, assigned attorney docket no. T0709.70038US01, titled “Information Carrier and System for Acquiring Information,” published as U.S. Patent Pub. No. 2013/0284578, all of which are incorporated herein by reference to the extent permitted by law.

As used herein, “color” may refer to a property of an object which produces a particular visual sensation, or to the visual sensation produced, and/or to a wavelength of light which produces a particular visual sensation, depending on the context.

In some embodiments, a smart ad system (or “smart ad”) may comprise a multi-layer computation, communication, and I/O system that is as flat as practical and as flexible as is practical such that it can be inserted into a magazine or other printed object, though embodiments are not limited to this specific application. In some embodiments, a smart ad system may be inserted into and/or attached within printed material including but not limited to at least one of a card, greeting card, magazine, newspaper, book, brochure, and/or advertisement, and/or may be mounted to an article including but not limited to a box, tray, window, poster, wall, point of purchase display, billboard, and/or area that can be seen. Some embodiments of a smart ad system may be used in any number of applications, with any subset of capabilities described in the present disclosure.

In some embodiments, a smart ad system may perform the same functions as a computer, and brings all the power of computer technology to advertisements that are made flat enough to fit in printed material like magazines. In the context of printed advertisements, some embodiments of the smart ad system may enable data input, data output, communication with other devices and the outside world, and/or display, and/or may serve as a peripheral and/or a source of control for any number of devices. In some embodiments, a smart ad system may include a printed substrate and multi-layer computation, communication, and/or I/O system comprising at least one power source, a processor with memory, circuitry, at least one input, at least one output, a structure configured to display data and/or color, at least one structure configured to receive data, and/or at least one structure configured to transmit data.

### Manufacturing a Smart Ad System

In some embodiments, the components of a smart ad system (e.g., a power source, an input/output unit, a display unit, a mechanical structure, and/or a communication unit) may be included in (e.g., etched in, deposited on, or printed on) one or more layers of a structure, such as a thin film structure.

In some embodiments, a layer of a smart ad system may include any suitable material, including, but not limited to, one or more plastics (e.g., thermoplastics), one or more papers, one or more polymers (e.g., polycarbonate, polyethylene, polyurethane, polyester, and/or polyvinylchloride), blends of two or more polymers (e.g., a blend of polycarbonate and polyethylene), other polymeric materials, thermo-formable materials, materials that maintain shape after being exposed to heat and/or pressure, and/or any other material suitable for forming a smart ad system.

In some embodiments, a layer of a smart ad system may comprise a film (e.g., a thin film). In some embodiments, a film (e.g., thin film) may include a layer of any material having an average thickness less than approximately 0.030″, between 0.030″ and 0.010″, between 0.010″ and 0.001″, or less than 0.001″. In some embodiments, a film (e.g., thin film) may comprise a monomolecular layer.

In some embodiments, two or more components of a smart ad system may be integrated in a same structure (e.g., formed in a same layer of material, formed in one or more layers of a same multi-layer structure, printed on a same layer of material, and/or printed on one or more layers of a same multi-layer structure). The structure may include, but is not limited to, a film (e.g., a thin film) of one or more film layers.

In some embodiments, one or more components of a smart ad system may comprise and/or be at least partially formed from one or more conductive inks. In some embodiments, conductive connections (e.g., wires, traces, and/or vias) between components may comprise and/or be at least partially formed from one or more conductive inks. In some embodiments, a smart ad system may include a light-inhibiting material, and such light-inhibiting material may comprise and/or be formed from one or more conductive inks. In some embodiments, a conductive ink may comprise a conductive material that may be formed by the evaporation and/or curing of a binder/carrier liquid in which a conductive material is suspended. Examples of conductive inks may include, but are not limited to, metallic inks, such as aluminum ink.

### Power Source

In some embodiments, a power source of a smart ad system may include at least one of the following: a low profile battery, a capacitor, an electromagnetic power source, an inductive power source, a radio-frequency (RF) power source, a piezoelectric power source, and/or a solar power source. The low profile battery can be at least one of the following: printed, flat, constructed, discrete, rechargeable and/or non-rechargeable. In some embodiments, a power source (e.g., battery) may be printed on or otherwise attached to a film.

### Input/Output Unit

In some embodiments, an input and/or output unit (“input/output unit” or “I/O unit”) may include at least one switch. In some embodiments, the switch may be of any suitable type, including, but not limited to, a capacitive type, a membrane type, a low force membrane type, a force sensitive resistance type, a touch sensitive resistance type, a multi-layer type consisting of conductive layers and spacers, a dome type, a discrete type, and/or a mechanical type. The switch may be configured, in some embodiments, as at least one linear and/or area matrix. The switch may include, in some embodiments, at least one variable resistance touch sensitive rheostat.

In some embodiments, an I/O unit may comprise at least one sensor. In some embodiments, the sensor may produce at least one signal that may be detected by circuitry of the smart ad system. In some embodiments, a sensor may be configured to sense at least one of the following: humidity, temperature, light, color, spatial orientation, magnetic field and/or earth's magnetic field. In some embodiments, the sensor may be configured to receive a GPS position (e.g., the sensor may include a GPS receiver). In some embodiments, the sensor may detect infrared and/or visible and/or UV light and/or acoustic energy.

In some embodiments, an I/O unit may include auxiliary circuitry, which may function as a wireless phone. The auxiliary circuitry configured as a wireless phone may have at least one preprogrammed number. In some embodiments, an I/O unit may include one or more conductive touch codes configured to be read and/or sensed by a touch sensitive screen.

In some embodiments, an input/output unit (e.g., a capacitive switch) may be printed on, deposited on, or otherwise attached to a film. In some embodiments, an input/output unit (e.g., a capacitive switch) may comprise a conductive ink.

### Mechanical Structure

In some embodiments, the smart ad system may comprise a mechanical structure. The mechanical structure may, in some embodiments, be flat. In some embodiments, the mechanical structure may contain and/or be powered by a mechanical component, including, but not limited to a motor, a solenoid, nitinol, and/or a piezoelectric device. The mechanical component may, in some embodiments, be as flat as possible. In some embodiments, the mechanical structure may comprise a flat or substantially flat pop-up mechanism configured to fold out from the plane of storage and/or to increase in height and/or length in the third dimension.

### Display Unit

In some embodiments, the display unit may be configured to display data and/or color. In some embodiments, the display unit may comprise at least one viewing area in which light can be seen by a viewer. In some embodiments, this area may comprise a decoratively printed front sheet that allows light to be distributed throughout the entire viewing area. In some embodiments, the viewing area may be configured to display data and/or color in any suitable form, including, but not limited to, geometric shapes, letters, numbers, symbols, words, phrases, logos, cartoon and/or other characters, celebrity likenesses, commonly recognized places and/or buildings and/or structures and/or objects. In some embodiments, the display unit may comprise at least one infrared (IR) light-emitting diode (LED) and/or at least one visible LED and/or at least one ultraviolet (UV) LED and/or at least one multi-color LED. A multi-color LED may be configured to produce light of two or more wavelengths, such as red, blue, and green light. In some embodiments, the display unit may include control circuitry configured to control the mixture of light emitted by the LEDs, and further, a plurality of colors and/or lighting patterns may be produced. In some embodiments, colors and/or lighting patterns may be produced when at least one input unit (e.g., switch or sensor) is depressed and/or activated. In some embodiments, the control circuitry may enable the plurality of colors to fade up in brightness and/or fade down in brightness and/or to fade from one color to another and/or to instantly change colors and/or brightness.

In some embodiments, a display unit may include one or more light-emitting components, including, but not limited to, electroluminescent devices, light-emitting diodes (LEDs), organic LEDs, polymer LEDs, light-emitting polymers, and/or any other suitable material or structure capable of emitting light.

### Communication Unit

In some embodiments, the communication unit may be configured to receive data and/or to transmit data. In some embodiments, the communication unit may transmit and/or receive data using any suitable communication device, resource, and/or protocol, including, but not limited to, radio-frequency identification (RFID) device, near field communication (NFC) device, unpowered NFC chip tag, Bluetooth in 2400-2480 MHz band, Bluetooth in bands now known or unknown, frequency hopping spread spectrum based systems, Wifi, Zigbee IEEE 802.15 standard, and/or communication devices for use in industrial, scientific, and medical bands utilizing 686 MHz in Europe and/or 915 MHz in the U.S. and/or 2.4 GHz in one or more jurisdictions. In some embodiments, the data may be encrypted.

### Functions of a Smart Ad System

In some embodiments, a smart ad system may enable communication to occur with and between itself and at least one of the following: a smart device, computer, directly to the internet, to a smart device connected to the internet, to a computer connected to the internet, and/or to another smart ad or a smart device and/or a smart item. In some embodiments, a smart ad system may send and/or receive color information. For example, a smart ad system may send color information to a smart device for subsequent display, and/or for subsequent retransmission of color information to other systems capable of displaying the color represented by color information. In some embodiments, a smart ad system that receives color information may perform color correction such that the color generated by the smart ad system is the same or similar to the color represented by the color information. For example, a smart ad system may perform color correction such that the color generated by the smart ad system is the same or similar to a color generated by another display device. In some embodiments, performing the color correction may comprise altering the color information.

In some embodiments, the smart ad system may be configured to perform one or more functions, including, but not limited to, ordering goods and/or services, selecting and/or transmitting colors for display on another smart device, selecting and/or transmitting colors to be printed on an item, displaying a color palette, using one or more remote standard color swatches and/or samples to perform color calibration, customizing colors on other color producing elements, changing one or more colors of wearable clothing, apparel, an accessory, hairclip, tiara, and/or jewelry, causing a phone to change colors and/or patterns, changing color on a bike, motorcycle, ski, item of sports equipment, hood ornament, molding, and/or area trim, changing color of smart paint and/or area color display of at least one wall and/or portion of a wall, room, surface, and/or sconce, interfacing with HUE from Philips, wirelessly controlling lighting, dimming a display and/or lighting at known and/or settable rate, performing color transition at known and/or settable rate, controlling a room environment (including, but not limited to, lighting, temperature and/or HVAC settings), controlling 3D printing and/or printers, controlling an entertainment system, tuning a radio and/or TV, ordering movies from an online entertainment service (e.g., Netflix, movie providers, and/or movie on demand providers now known or unknown), and/or controlling analog levels (including but not limited to controlling sound volume and/or channel balance, and/or tuning radio and/or television channels).

In some embodiments, a smart ad system may perform one or more functions including, but not limited to, facilitating a communication to or within a social network and/or application, accessing and/or causing access to textual, audio, and/or video content, facilitating engagement in a marketing campaign, causing communication with any network based application interface, updating a data store (e.g., for the purpose of providing analytical insight of that data), and/or choosing colors (e.g., colors to be displayed by the smart ad system, by another smart ad system, and/or by another device).

In some embodiments, a smart ad system may comprise at least one power source, a processor with memory, circuitry, at least one input and/or output unit, a display unit configured to display data and/or color, and/or at least one communication unit. In some embodiments, the smart ad system may be inserted into and/or attached within printed material including but not limited to cards, greeting cards, magazines, newspapers, books, brochures, and/or advertisements. In some embodiments, the smart ad system may be mounted to an article and/or structure including but not limited to a box, a tray, a window, a poster, a wall, a point of purchase display, a billboard, and/or any visible area of an article and/or structure.

### Color Calibration

A smart ad system may, in some embodiments, transmit color settings to a smart device. In some embodiments, the color settings may comprise color settings used by the smart ad system to produce (e.g., emit, transmit, reflect, generate, and/or display) a corresponding color. In some cases, it may be desirable for the smart device receiving the color settings to display the same color produced by the smart ad system when the smart ad system applies those color settings. However, in some cases, a smart ad system and a smart device which apply the same color settings may produce different colors. In some embodiments, the color settings may be calibrated (e.g., “corrected”), such that the color produced by the smart device in response to applying the corrected color settings is the same as the color produced by the smart ad system in response to applying the original color settings. In this manner, calibrating the color settings may facilitate accurate reproduction of a same color by multiple devices (e.g., multiple devices disposed in different locations, operating under different lighting conditions, using different display units, and/or using differently calibrated display units).

As just one example, if a color is being produced on a smart ad system and it is desired to duplicate this color on a second device (e.g., a second smart ad system or another smart device), in some embodiments one or more corrections may be applied to the color settings (e.g., red, blue, and green values of the LEDs producing the specified desired color in the smart ad system) because applying the uncorrected color settings in the second device may produce a different color. In some embodiments, calibrating (e.g., “correcting”) the color settings for the second device may result in the second device accurately reproducing the color.

In some embodiments, the smart ad system may include one or more components configured to facilitate color calibration, including, but not limited to, at least one camera, and/or a processor (e.g., processing circuit) configured to perform a color calibration method. In some embodiments, the color calibration method may include one or more of the following steps:
(STEP 202) Using the camera to acquire an image of at least one sample color standard of known chromaticity coordinates;
(STEP 204) Using the processor to resolve the image of the at least one sample color standard of known chromaticity coordinates into component color contributions (e.g., red, blue, and green component percentages, namely Rsti, Bsti, and Gsti, respectively, where subscript i is the ith sample and can be any whole number up to a maximum number of color standard samples); and
(STEP 206) Using the processor to produce a color acquisition map between the chromaticity coordinates of the one or more color standard samples and the corresponding component color contributions.

According to an aspect of the present disclosure, a smart device may be configured to perform color calibration. In some embodiments, a smart device may include one or more components configured to facilitate color calibration, including, but not limited to, at least one camera, at least one display unit, one or more input controllers, and/or a processor (e.g., processing circuit) configured to perform a color calibration method. In some embodiments, the color calibration method may include one or more of the following steps:
(STEP 302) Use the at least one display unit to display one or more test colors by applying one or more respective sets of display settings to components of the display unit. In some embodiments, a set of display settings may comprise color component contributions of a target color (e.g., red, green, and blue color component contributions, denoted Rg, Gg, and Bg, respectively, where subscript g indicates a component color contribution value corresponding to the gth test color). In some embodiments, the color component contributions of the target color may be determined by acquiring an image of the target color and resolving the image of the target color into the corresponding color component contributions. In some embodiments, the test color may cover at least a portion of the visible band.
(STEP 304) Use the one or more input controllers to configure a camera of the smart device to acquire one or more images of the one or more test colors displayed by the display unit in response to application of the one or more respective sets of display settings.
(STEP 306) Use the processor to resolve the one or more images of the one or more test colors into one or more respective sets of average component color contributions (e.g., red, green, and blue average component color contributions denoted Rs, Gs, and Bs, respectively, where subscript s is the sth average component color contribution corresponding to the gth test color).
(STEP 308) Use the processor to calculate one or more differences between (1) the one or more sets of display settings applied to produce the one or more test colors, and (2) the corresponding one or more sets of average component color contributions resolved from the one or more images of the test colors. In some embodiments, the elements of a difference between a set of display settings and a set of average component color contributions may be calculated as Rsd=(Rg−Rs), Gsd=(Gg−Gs), and Bsd=(Bg−Bs). In some embodiments, the one or more differences may be calculated over at least a portion of the visible band.
(STEP 310) Use the one or more differences between the one or more sets of display settings and the one or more sets of average component color contributions to determine elements of a color correction matrix for converting average component color contributions of a color (e.g., a target color to be displayed by the display unit and/or a test color displayed by the display unit) into display settings which, when applied to the display unit, cause the display unit to display a target color.
In some embodiments, the values of the matrix elements corresponding to a target color may comprise corrected display settings (e.g., corrected red, blue, and green display settings denoted Rcorrected, Bcorrected, and Gcorrected, respectively) which, when applied to the display unit of the smart device, cause the smart device to display the target color. In some embodiments, the values of the matrix elements corresponding to a target color may comprise display setting difference values (e.g., red, blue, and green display setting difference values denoted Rdiff, Bdiff, and Gdiff, respectively) which, when combined with (e.g., added to) the component color contributions of the target color, yield corrected display settings which, when applied to the display unit of the smart device, cause the smart device to display the target color.
In some embodiments, one or more elements of the color correction matrix may comprise a function of a color (e.g., a target color and/or a test color). In some embodiments, a function of a color may comprise a function of the chromaticity coordinates of a color (e.g., target color and/or a test color) and/or a function of component color contributions of a color (e.g., target color and/or a test color).
In some embodiments, the elements (e.g., functions) of the color correction matrix may be determined by interpolating data associated with the one or more test colors. In some embodiments, the elements (e.g., functions) of the color correction matrix may be determined by performing linear interpolation between data associated with two test colors (e.g., by performing linear interpolation between the difference values associated with the two test colors, such as the difference values calculated at step 308). In some embodiments, the elements of the color correction matrix may be determined by performing multi-dimensional interpolation (e.g., nearest-neighbor interpolation, Barnes interpolation, bilinear interpolation, bicubic interpolation, Delaunay triangulation, inverse distance weighting, Kriging, natural neighbor interpolation, spline interpolation, Bezier surface interpolation, or Lanczos resampling) among data associated with three or more test colors (e.g., by performing multi-dimensional interpolation among the difference values associated with the three or more test colors, such as the difference values calculated at step 308).
In some embodiments, the color correction matrix may comprise corrected display settings or display setting difference values calculated for a color sample generated by the smart device (or for component color contributions of a target color to be displayed by the smart device). In some embodiments, the corrected display settings or display setting difference values for a color sample (or for component color contributions of a target color) may depend on the proportional location of the color coordinates of the color sample (or the color coordinates of the component color contributions of the target color) within the color coordinates of a shape (e.g., a triangle) formed by surrounding test colors, or on the proportional location along a line formed by a first test color, the color sample generated by the smart device (or the color coordinates of the component color contributions of the target color), and the second test color.
In some embodiments, the color correction matrix may include three elements. In some embodiments, the color correction matrix may be two-dimensional.
In some embodiments, the display settings corresponding to a test color may be the same as the color component contributions of a target color (e.g., a target color in an image acquired by the at least one camera, a target color specified by another device, etc.).

In some embodiments, a smart device (e.g., smart ad system) may perform a color calibration method comprising one or more of the following steps:
(STEP 402) Use the camera of the smart device to acquire an image of a target color generated by a second device;
(STEP 404) Use the processor of the smart device to resolve the image of the target color into average component color contributions (e.g., red, green, and blue average component color contributions denoted Rs, Gs, and Bs, respectively);
(STEP 406) Use the processor of the smart device to determine calibrated display settings (e.g., red, green, and blue calibrated display settings denoted Rcalibrated, Bcalibrated, and Gcalibrated, respectively) which, when applied to the at least one display unit of the smart device, cause the at least one display unit to display the target color. The calibrated display settings may be determined based on values of the color correction matrix corresponding to the average component color contributions of the image of the target color.

In some embodiments, the second device may be a smart ad system. In some embodiments, the calibrated display settings of the smart device (e.g., Rcalibrated, Bcalibrated, Gcalibrated) corresponding to a target color, and/or the average component color contributions of the target color may be transmitted by the smart device to at least one third device for color corrected display. The third device may comprise any number of devices whereby the calibrated display settings and/or average component color contributions are serially passed from a third device to another third device and so on until at least one third device finally displays the color corrected target color.

In some embodiments, the input controllers (which may be used to configure the camera of a smart device to acquire an image generated on the screen display on the same smart device) may comprise one or more mirrors (e.g., at least three planar mirrors and/or at least one curved mirror). In some embodiments, the input controllers may comprise a light pipe and/or light guide configurable to enable the passage of light from the display screen of the smart device to the camera of the same smart device.

Although some embodiments have been described it will be understood by those skilled in the art that the present invention should not be limited to the described embodiments. Rather, various changes and modifications can be made within the spirit and scope of the present disclosure.

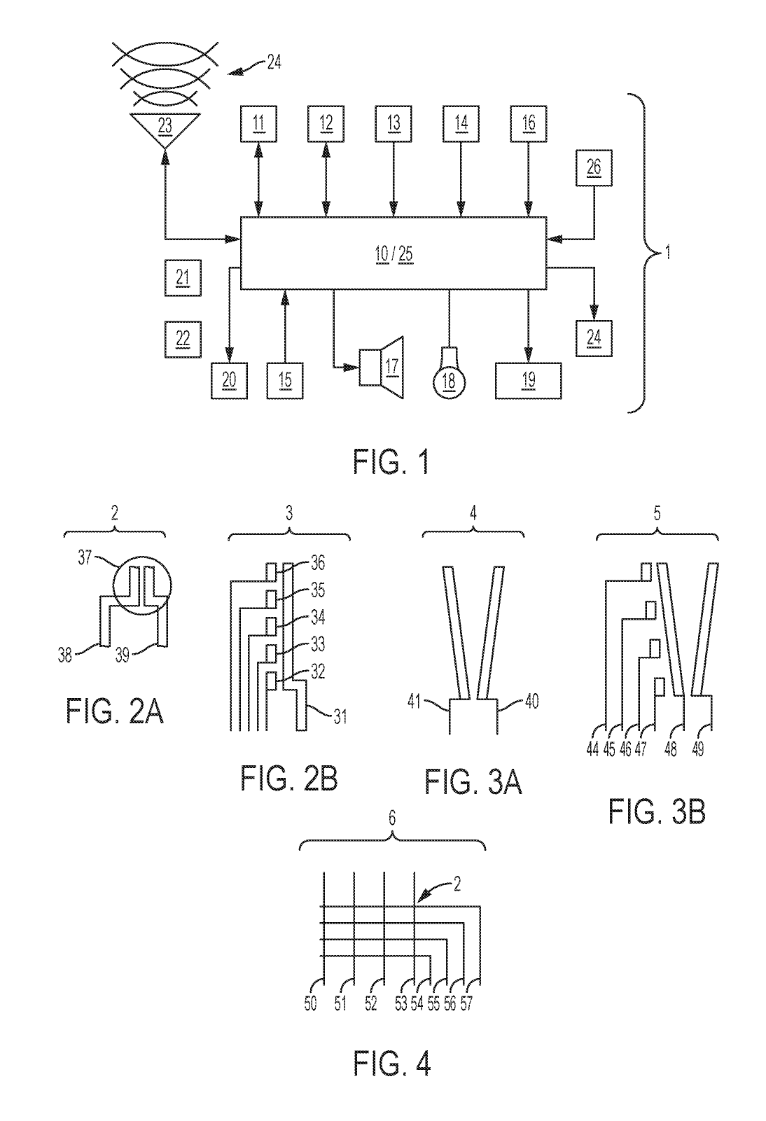

FIG. 1 shows constituent components of a smart ad system 1, according to some embodiments. A processor 10 (e.g., CPU) is shown along with auxiliary circuitry 25 which may be configured to process front end signals and/or post process signals output from the processor 10. In some embodiments, battery 11 may power the smart ad system 1. In some embodiments, capacitor 12 may store energy harvested from one or more sources and/or filter electrical noise. In some embodiments, power may be provided from piezo input 13, which may generate power due to mechanical flexing and/or harvest power from ambient acoustic energy. In some embodiments, power may be provided by solar cell 14. In some embodiments, touch points 15 may serve as inputs to the processor 10 and/or auxiliary circuitry 25. In some embodiments, one or more sensors 16 may provide input information depending on the application. The one or more sensors 16 may include any suitable type of sensor, and the one or more sensors may sense any suitable thing including but not limited to humidity, temperature, infrared and/or visible and/or UV light, color, spatial orientation, magnetic field and/or earth's magnetic field. In some embodiments, sound may be produced by speaker 17. In some embodiments, acoustic energy may be detected by microphone 18. In some embodiments, flat mechanisms 19 may be operated. In some embodiments, light in the form of color or information display may be generated by LEDs 20 and/or LCD display 24. In some embodiments, smart ad system 1 may include touch codes 21, which may be readable by other smart devices. In some embodiments, QR codes 22 may be printed on smart ad system 1. The QR codes 22 may be readable by smart devices. In some embodiments, an antenna 23 may serve as a receiving antenna for receiving data from an RF or wireless source and/or as a transmitting antenna for outputting data as an RF or wireless signal. In some embodiments, antenna 23 may receive energy as in RFID systems and harvest energy (e.g., supplemental energy) to power the smart ad system. Depending upon the application, any combination of components herein mentioned may be used.

Touch points 15 may take the form of many types of embodiments. FIG. 2A shows a single touch sensitive switch 2, which includes left contact 38 and right contact 39, which form a touch sensitive zone 37 configured to form a resistive path between left contact 38 and right contact 39 in response to application of pressure (e.g., by a finger). FIG. 2B shows a linear array of touch sensitive switches 3. Shown is a five switch array consisting of touch sensitive switch common 31, first contact 32, second contact 33, third contact 34, fourth contact 35, and fifth contact 36. Other linear arrays of different sizes may be constructed depending upon the application and the example shown is for illustrative purposes only. FIG. 3A depicts touch sensitive rheostat 4 configured to offer increased electrical resistance as the distance between left rail 41 and right rail 40 increases (e.g., in response to a finger being slid between and making simultaneous contact with right rail 40 and left rail 41). FIG. 3B depicts a touch sensitive rheostat with touch sensitive position switches 5. The touch sensitive rheostat is formed by position sensitive left rail 48, and position sensitive right rail 49. The resistance offered by the touch sensitive rheostat is configured to change in response to an object (e.g., a finger) being slid between the two rails. Also incorporated in the touch sensitive rheostat of FIG. 3B is a first position switch 47, second position switch 46, third position switch 45, and fourth position switch 44, and these switches are closed when bridging contact is made between the switch and the position sensitive left rail 48 which serves as the common for the four switches. Other numbers of position switches can be used depending upon the application and the example shown is for illustrative purposes only.

FIG. 4 shows input touch points 15 configured as a matrix 6. The matrix 6 shown is composed of sixteen single touch sensitive switch 2 elements formed from eight I/O lines including first vertical bus 50, second vertical bus 51, third vertical bus 52, fourth vertical bus 53 and first horizontal bus 54, second horizontal bus 55, third horizontal bus 56, and fourth horizontal bus 57. Other matrices of different sizes may be constructed depending upon the application and the example shown is for illustrative purposes only.

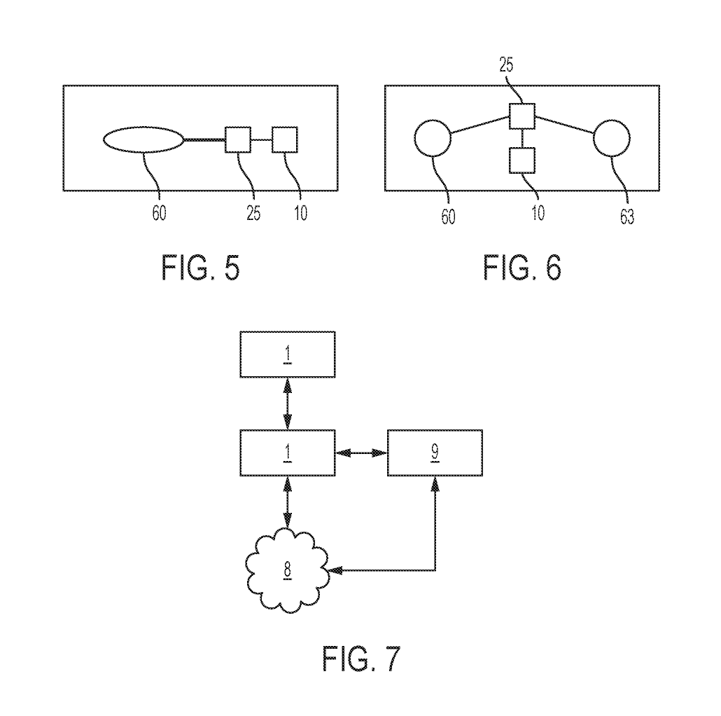

FIG. 5 shows a capacitive sensor subsystem which could either be considered a different type of touch point (touch points 15) or other inputs 26. The capacitive switch includes a first capacitive touch point 60 which connects to auxiliary circuitry 25 which feeds a signal to processor 10. The auxiliary circuitry 25 may be configured to process capacitance to produce a binary signal or to provide a quantifiable variable signal for applications where variable inputs are desirable. FIG. 6 shows a first capacitive touch point 60 and a second capacitive touch point 63 both connecting to auxiliary circuitry 25 which feeds the respective signals to processor 10. Though only two capacitive switches are shown in FIG. 6 it should be understood that any number can be used, depending upon the application.

FIG. 7 shows a smart ad system 1a communicating with other devices, according to some embodiments. Shown is bidirectional communication between smart ad system 1a and an external smart device 9. External smart device 9 may comprise a smart phone, a tablet, a computer, and/or any device capable of communicating by any suitable technique, including, but not limited to wifi, RFID, Bluetooth, electromagnetic communication, IR, optical methods, and/or other suitable techniques. Also shown is bidirectional communication between smart ad system 1a and the internet 8, which can either be a wireless connection or a connection using a physical cable (not shown). Also shown is bidirectional communication between smart ad system 1a and a second smart ad system 1b.

FIG. 12 shows a chromaticity chart depicting color being resolved into an x chromaticity coordinate 99 and y chromaticity coordinate 98. Coordinates of the colors red 92, blue 93, and green 91 are labeled on the chromaticity chart. Also labeled are the coordinate of what is commonly referred to as CIE white 90, which may be produced on a display screen from a mixture of red, blue, and green light (e.g., a mixture of red, blue, and green light produced from a red LED, a blue LED, and a green LED).

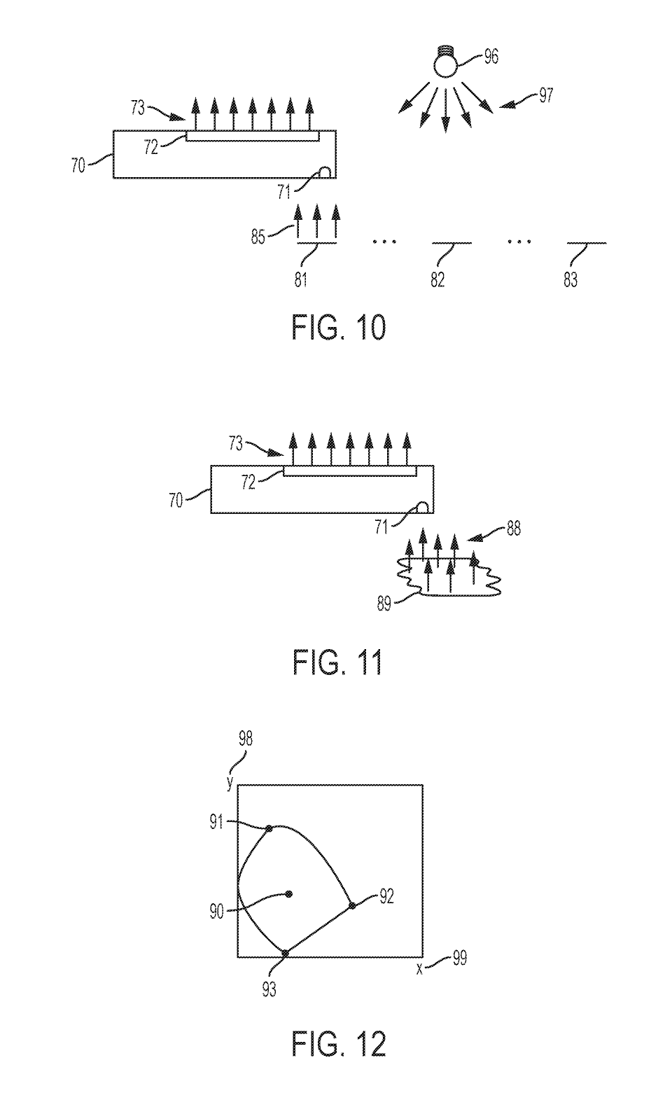

FIG. 10 shows a smart phone 70 using its own camera 71 to acquire images from the light corresponding to a set of known color standards 81-83. Also shown are screen 72 of the phone 70 and light 73 produced (e.g., reflected, transmitted, emitted, generated, and/or displayed) by screen 72. Depicted is a first known color standard 81 from which light 85 is reflected to camera 71. In the smart phone 70, the image corresponding to the first known color standard 81 is resolved into its corresponding components (e.g., red, blue, and green components). Illuminating light source 96 produces illuminating light 97, which reflects off color standard 81 as reflected light 85. More than one color standard may be imaged by the camera 71, each being resolved similarly into respective components (e.g., red, blue, and green components). Also shown are the ith known color standard 82 and the Nth known color standard 83, each being resolved into components (e.g., red, blue, and green components). Any suitable color standards may be used including but not limited to CIE white 90 as depicted in FIG. 12.

FIG. 11 shows a smart phone 70 using its own camera to acquire an image corresponding to the light 88 radiated from light generation area 89 (e.g., a display unit) of a smart ad. The acquired image is subsequently resolved into components (e.g., red, blue, and green components).

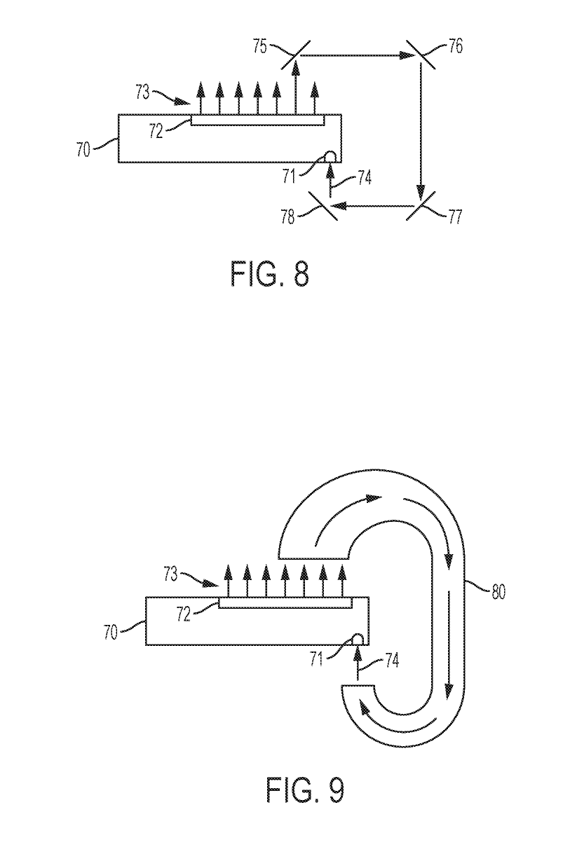

FIG. 8 shows a smart phone 70 using its own camera 71 to acquire an image corresponding to the light 73 produced by the camera's display screen 72, according to some embodiments. In FIG. 8, the smart phone uses mirrors to direct light from the display 72 to the camera 71. The configuration illustrated in FIG. 8 may, in some embodiments, be used for the purpose of auto color calibration. In some embodiments, test colors with red, blue, and green color components denoted Rg, Gg, and Bg, respectively, may be generated and displayed on the screen 71. Light 73 from screen 71 impinges on first mirror 75, which reflects light onto second mirror 76, which reflects light onto third mirror 77, which reflects light onto fourth mirror 78, which reflects light 74 onto camera 71, thus enabling camera 71 to acquire an image of the light from screen 73. Any suitable number of mirrors may be used, and mirrors of any suitable type may be used. Smart phone 70 may subsequently resolve the image into red, blue, and green components Rs, Gs, Bs. Using the displayed color components (Rg, Gg, Bg) and the imaged color components (Rs, Gs, Bs), the smart phone may calculate the difference between the imaged and displayed color components ((Rg−Rs), (Gg−Gs), (Bg−Bs)), where the g subscript is the gth component of the gth test color generated, and the s subscript is the sth component of the sth test color imaged.

FIG. 9 shows a smart phone 70 using its own camera 71 to acquire an image corresponding to the light 73 produced by the camera's display screen 72, according to some embodiments. In FIG. 9, the smart phone uses a light feedback pipe 80 to direct light from the display 72 to the camera 71. The configuration illustrated in FIG. 9 may, in some embodiments, be used for the purpose of auto color calibration. In some embodiments, light feedback pipe 80 may comprise a one piece element that performs the same function as the mirrors of FIG. 8.

In some embodiments, the color correction technique is desensitized to the attributes of the illuminating light (e.g., the color components of the illuminating light) because irrespective of the color components into which a sample color is resolved, the color components of the sample color are known. So if a known color sample resolves into Rk, Gk, Bk when illuminated by some arbitrary light source, and an unknown color produces the same R, G, B components when illuminated by the same light source, the unknown color is the same as the known color at least to a first order approximation.

1. A smart device comprising:
at least one camera; and
a processor configured to perform a method, the method comprising:
controlling the at least one camera to acquire one or more images of one or more respective color standard samples of known chromaticity coordinates;
resolving the one or more images of the one or more color standard samples of known chromaticity coordinates into component color contributions; and
producing a color acquisition map between the chromaticity coordinates of the one or more color standard samples and the corresponding component color contributions.

2. The smart device of claim 1, wherein producing the color acquisition map between the one or more color standard samples and the corresponding component color contributions comprises producing the color acquisition map using (1) one or more sets of chromaticity coordinates corresponding to the one or more color standard samples and (2) the component color contributions corresponding to the one or more images.

3. A smart device comprising:
at least one camera;
at least one display unit;
an input controller configured to determine an input to the at least one camera;
a processor configured to perform a color calibration method, the method comprising:
controlling the at least one display unit to display one or more test colors by applying one or more respective sets of display settings to components of the at least one display unit;
controlling the one or more input controllers to provide light produced by the at least one display unit to the at least one camera;
controlling the at least one camera to acquire one or more images of the one or more test colors displayed by the at least one display unit in response to application of the one or more respective sets of display settings;
resolving the one or more images of one the one or more test colors into one or more respective sets of average component color contributions;
determining one or more differences between (1) the one or more sets of display settings applied to produce the one or more test colors, and (2) the corresponding one or more sets of average component color contributions resolved from the one or more images of the one or more test colors; and
using the one or more differences between the one or more sets of display settings and the one or more sets of average component color contributions to determine elements of a color correction matrix for converting average component color contributions of a specified color into display settings which, when applied to the display unit, cause the display unit to display a target color.

4. The smart device of claim 3, wherein the one or more sets of display settings comprise a first set of display settings, and wherein the first set of display settings comprises color component contributions of a target color.

5. The smart device of claim 4, wherein the method further comprises:
controlling the at least one camera to acquire an image of the target color; and
resolving the image of the target color into the color component contributions corresponding to the target color.

6. The smart device of claim 4, wherein the method further comprises receiving the color component contributions of the target color from a second device.

7. The smart device of claim 4, wherein the method further comprises:
receiving an image of the target color from a second device; and
resolving the image of the target color into the color component contributions corresponding to the target color.

8. The smart device of claim 7, wherein said second device comprises a smart ad system.

9. The smart device of claim 3, wherein the specified color comprises a target color to be displayed by the at least one display unit.

10. The smart device of claim 3, wherein the specified color comprises a test color displayed by the at least one display unit.

11. The smart device of claim 3, wherein the input controller comprises at least three planar mirrors and/or at least one curved mirror.

12. The smart device of claim 3, wherein the input controller comprises a light pipe and/or light guide configurable to guide light from said at least one display unit to said at least one camera.

13. The smart device of claim 3, wherein values of the elements of the color correction matrix comprise calibrated display settings which, when applied to the at least one display unit, cause the at least one display unit to display the target color.

14. The smart device of claim 3, wherein values of the elements of the color correction matrix comprise display setting difference values which, when combined with component color contributions of the target color, yield calibrated display settings, and wherein the calibrated display settings, when applied to the display unit of the smart device, cause the smart device to display the target color.

15. The smart device of claim 3, wherein at least one element of the color correction matrix comprises a function of (1) a color, (2) chromaticity coordinates of a color, and/or (3) component color contributions of a color.

16. The smart device of claim 3, wherein the one or more differences comprise first and second sets of differences between first and second of the one or more sets of display settings and first and second of the one or more sets of average component color contributions, respectively, and wherein using the one or more differences to determine elements of the color correction matrix comprises performing linear interpolation based on the first and second sets of differences.

17. The smart device of claim 3, wherein the one or more differences comprise first, second, and third sets of differences between first, second, and third of the one or more sets of display settings and first, second, and third of the one or more sets of average component color contributions, respectively, and wherein using the one or more differences to determine elements of the color correction matrix comprises performing multi-dimensional interpolation based on the first, second, and third sets of differences.

18-29. (canceled)

30. An electronic device comprising:
components, the components including a power source, a processor, a memory, circuitry, an input/output unit, a display unit configured to display data and/or color, and a communication unit configured to transmit and/or receive data; and
a conductive material connecting at least two of the components to each other,
wherein at least a portion of the electronic device is formed in one or more layers of a printed substrate, and/or at least one of the components is formed from a conductive ink.

31-79. (canceled)
